(19) United States
(12) Patent Application Publication
(10) Pub. No.: US 2015/0145871 A1
(43) Pub. Date: May 28, 2015

(54) SYSTEM, METHOD, AND COMPUTER PROGRAM PRODUCT TO ENABLE THE YIELDING OF THREADS IN A GRAPHICS PROCESSING UNIT TO TRANSFER CONTROL TO A HOST PROCESSOR

(71) Applicant: NVIDIA Corporation, Santa Clara, CA (US)

(72) Inventors: Steven Parker, Draper, UT (US); Andreas Dietrich, Heltersberg (DE)

(73) Assignee: NVIDIA Corporation, Santa Clara, CA (US)

(21) Appl. No.: 14/088,289

(22) Filed: Nov. 22, 2013

(51) Int. Cl. G06T 1/20; G06F 9/38

(52) U.S. Cl. CPC G06T 1/20; G06F 9/3836
USPC 345/505

(57) ABSTRACT

A method, system, and computer-program product are provided to enable the yielding by threads executing in a processing unit to transfer control to a host processor. The method includes the steps of receiving an intermediate representation of a program, replacing a yield instruction in the intermediate representation with a yield operation that includes one or more instructions, and compiling at least a portion of the modified intermediate representation into a machine code for execution on a parallel processing unit.

### FIELD OF THE INVENTION

The present invention relates to graphics processing units, and more particularly to the execution of threads on graphics processing units.

### BACKGROUND

Graphics processing units (GPUs) are highly parallel processors that are utilized to perform many complex parallel tasks such as generating two-dimensional (2D) images from three-dimensional (3D) models. Many modern GPUs implement a SIMD (single-instruction, multiple data) architecture that enables the GPU to process a plurality of different data across a number of threads executing substantially simultaneously on multiple processing units.

Typically, GPUs operate asynchronously from a host processor such as a central processing unit (CPU). In order to execute a task on the GPU, an application executing on the CPU may define the task in the memory and then launch a kernel execution on the GPU. In one implementation, an application executing on the CPU may copy data in addition to one or more program kernels (i.e., instructions) to a memory associated with the GPU. The application may also send instructions to the GPU that configure the GPU to execute the task. The GPU then launches the one or more program kernels and processes the data asynchronously from the application on the CPU. Once all of the program kernels have completed execution, the GPU notifies the application on the CPU that the task is complete and the application on the CPU may access the processed data.

In contrast to utilizing a large number of threads to perform a small amount of computations on a large set of data, some tasks may be better suited to utilize a small number of persistent threads to process parts of the overall task until no more work is left to complete. However, such persistent threads may be executed for a long time and the amount of work that each thread processes may be quite large, in some cases larger than the available memory for the thread in the local memory coupled to the GPU. In such cases, the GPU cannot complete the task without CPU intervention. However, current mechanisms do not provide a means for transitioning control between the GPU and the CPU except for when a task is complete. Therefore, such tasks are not able to be processed by conventional GPUs. Thus, there is a need for addressing this issue and/or other issues associated with the prior art.

### SUMMARY

A method, system, and computer-program product are provided to enable the yielding by threads executing in a processing unit to transfer control to a host processor. The method includes the steps of receiving an intermediate representation of a program, replacing a yield instruction in the intermediate representation with a yield operation that includes one or more instructions, and compiling at least a portion of the modified intermediate representation into a machine code for execution on a parallel processing unit.

### BRIEF DESCRIPTION OF THE DRAWINGS

FIG. 1 illustrates a flowchart of a method for enabling a parallel processing unit to yield control to a host processor, in accordance with one embodiment;

FIG. 2 illustrates a parallel processing unit (PPU), according to one embodiment;

FIG. 3 illustrates the streaming multi-processor of FIG. 2, according to one embodiment;

FIG. 4 illustrates a system for enabling threads executing on the PPU to yield control to a host processor, in accordance with one embodiment;

FIGS. 5A & 5B illustrate a flowchart for a method for modifying an intermediate representation of a program to implement a yield operation, in accordance with one embodiment;

FIGS. 5C & 5D illustrate a flowchart for a method for modifying an intermediate representation of a program to implement a yield operation, in accordance with another embodiment; and

FIG. 6 illustrates an exemplary system in which the various architecture and/or functionality of the various previous embodiments may be implemented.

### DETAILED DESCRIPTION

The present disclosure describes a mechanism for enabling active thread blocks executing on a parallel processing unit to yield control to a host processor at any point in the program by including a yield operation in the program. The yield operation comprises a number of instructions that cause the parallel processing unit to save state information to a data structure in a memory and halt execution of the active thread blocks. The state information may include register values and or other data stored in a memory accessible to the active thread blocks that is necessary to restore operation of the active thread blocks at a later point in time.

A programmer, an offline compiler, or a Just-In-Time (JIT) compiler generating code for the parallel processing unit may insert a yield instruction into the program that indicates that the thread blocks should yield control from the parallel processing unit to the host processor when the thread block reaches a continuation point. The continuation is a particular address location in the program that is determined by the JIT compiler when replacing the yield instruction with one or more instructions that comprise a yield operation. In the context of the present description, the yield instruction, as included in the intermediate representation, represents a single, unique semantic defined in the intermediate representation (such as through a library) as a placeholder for one or more instructions that comprise a yield operation (i.e., the instructions for saving state information to the memory and restoring state information to the parallel processing unit to resume execution of the thread block from a continuation point). In the context of the present description, the yield instruction, as included in a high-level shading language representation of the program, may also represent an application programming interface function call included in the high-level code for the program.

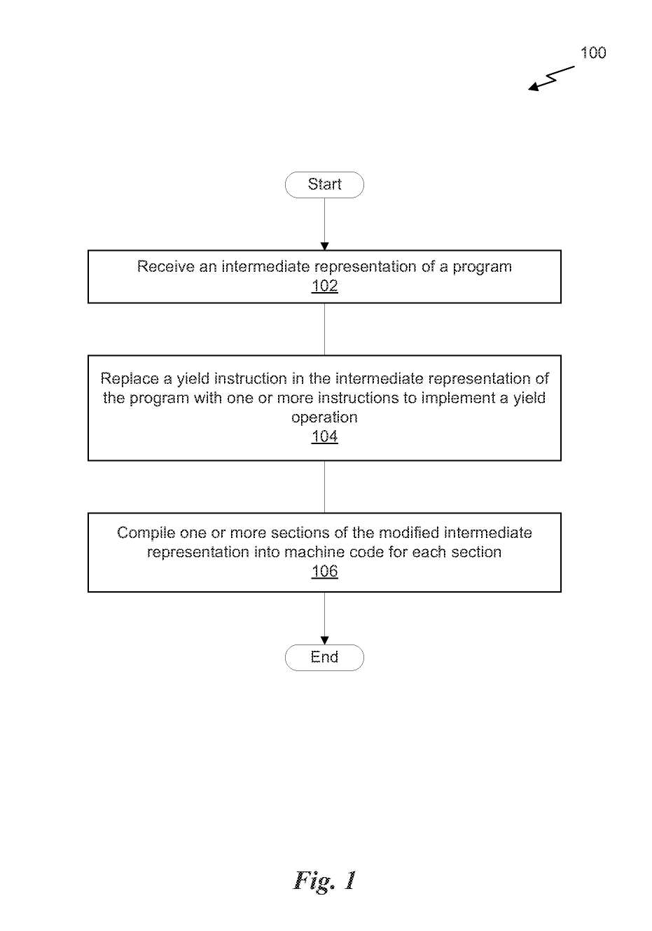

FIG. 1 illustrates a flowchart of a method 100 for enabling a parallel processing unit to yield control to a host processor, in accordance with one embodiment. At step 102, an intermediate representation of a program is received. In one embodiment, the intermediate representation of the program is written in a Parallel Thread Execution (PTX) instruction set architecture for the NVIDIA® CUDA programming platform. In another embodiment, the intermediate representation of the program is written in the Low Level Virtual Machine (LLVM) compiler infrastructure. The intermediate representation may be generated by a high-level programming language compiler such as a compiler for a high-level shading language like Cg (C for Graphics) or GLSL (OpenGL Shading Language), or for more general programming languages. At step 104, a yield instruction in the intermediate representation is replaced with a yield operation that includes one or more instructions. At step 106, at least a portion of the modified intermediate representation is compiled to generate a machine code for execution on a parallel processing unit. In one embodiment, the compiler is a JIT compiler implemented in a driver for the parallel processing unit.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

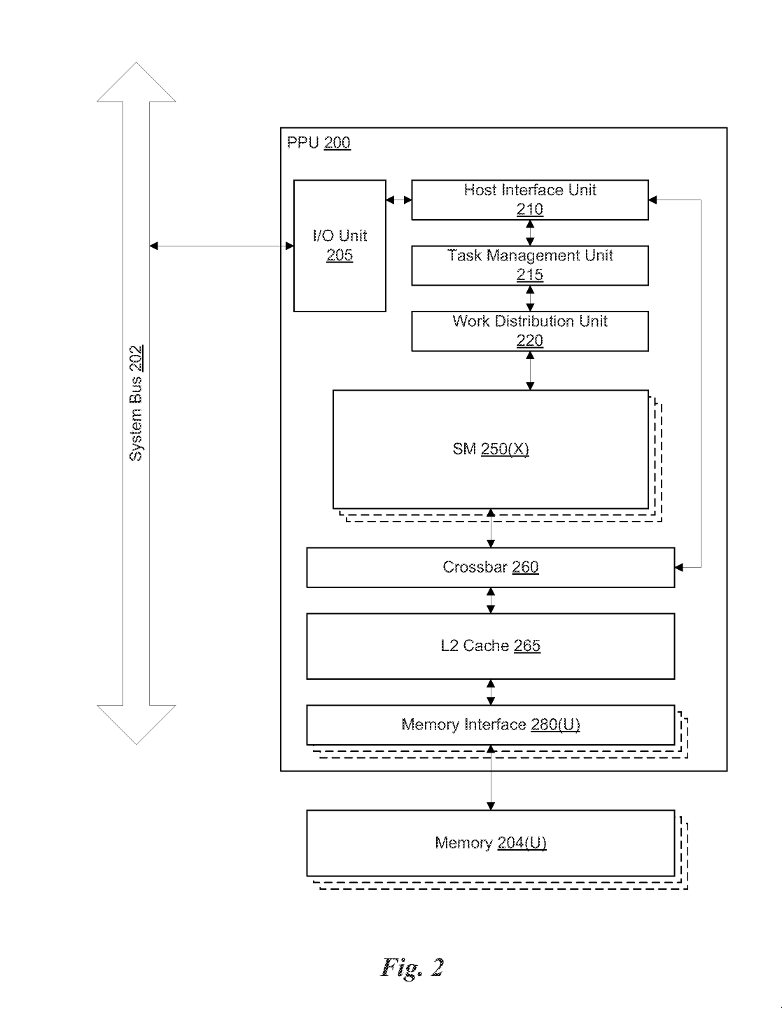

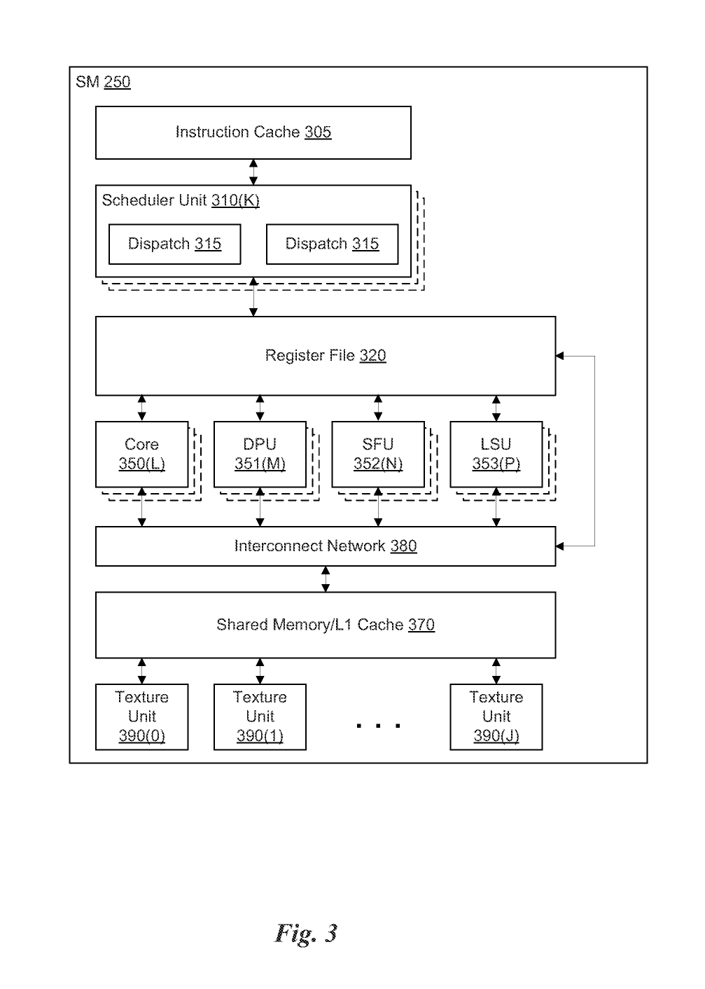

FIG. 2 illustrates a parallel processing unit (PPU) 200, according to one embodiment. While a parallel processor is provided herein as an example of the PPU 200, it should be strongly noted that such processor is set forth for illustrative purposes only, and any processor may be employed to supplement and/or substitute for the same. In one embodiment, the PPU 200 is configured to execute a plurality of threads concurrently in two or more streaming multi-processors (SMs) 250. A thread (i.e., a thread of execution) is an instantiation of a set of instructions executing within a particular SM 250. Each SM 250, described below in more detail in conjunction with FIG. 3, may include, but is not limited to, one or more processing cores, a local register file, one or more load/store units (LSUs), a level-one (L1) cache, shared memory, and the like.

In one embodiment, the PPU 200 includes an input/output (I/O) unit 205 configured to transmit and receive communications (i.e., commands, data, etc.) from a central processing unit (CPU) (not shown) over the system bus 202. The I/O unit 205 may implement a Peripheral Component Interconnect Express (PCIe) interface for communications over a PCIe bus. In alternative embodiments, the I/O unit 205 may implement other types of well-known bus interfaces.

The PPU 200 also includes a host interface unit 210 that decodes the commands and transmits the commands to the task management unit 215 or other units of the PPU 200 (e.g., memory interface 280) as the commands may specify. The host interface unit 210 is configured to route communications between and among the various logical units of the PPU 200.

In one embodiment, a program encoded as a command stream is written to a buffer by the CPU. The buffer is a region in memory, e.g., memory 204 or system memory, that is accessible (i.e., read/write) by both the CPU and the PPU 200. The CPU writes the command stream to the buffer and then transmits a pointer to the start of the command stream to the PPU 200. The host interface unit 210 provides the task management unit (TMU) 215 with pointers to one or more streams. The TMU 215 selects one or more streams and is configured to organize the selected streams as a pool of pending grids. The pool of pending grids may include new grids that have not yet been selected for execution and grids that have been partially executed and have been suspended.

A work distribution unit 220 that is coupled between the TMU 215 and the SMs 250 manages a pool of active grids, selecting and dispatching active grids for execution by the SMs 250. Pending grids are transferred to the active grid pool by the TMU 215 when a pending grid is eligible to execute, i.e., has no unresolved data dependencies. An active grid is transferred to the pending pool when execution of the active grid is blocked by a dependency. When execution of a grid is completed, the grid is removed from the active grid pool by the work distribution unit 220. In addition to receiving grids from the host interface unit 210 and the work distribution unit 220, the TMU 215 also receives grids that are dynamically generated by the SMs 250 during execution of a grid. These dynamically generated grids join the other pending grids in the pending grid pool.

In one embodiment, the CPU executes a driver kernel that implements an application programming interface (API) that enables one or more applications executing on the CPU to schedule operations for execution on the PPU 200. An application may include instructions (i.e., API calls) that cause the driver kernel to generate one or more grids for execution. In one embodiment, the PPU 200 implements a SIMD (Single-Instruction, Multiple-Data) architecture where each thread block (i.e., warp) in a grid is concurrently executed on a different data set by different threads in the thread block. The driver kernel defines thread blocks that are comprised of k related threads, such that threads in the same thread block may exchange data through shared memory. In one embodiment, a thread block comprises 32 related threads and a grid is an array of one or more thread blocks that execute the same stream and the different thread blocks may exchange data through global memory.

In one embodiment, the PPU 200 comprises X SMs 250(X). For example, the PPU 200 may include 15 distinct SMs 250. Each SM 250 is multi-threaded and configured to execute a plurality of threads (e.g., 32 threads) from a particular thread block concurrently. Each of the SMs 250 is connected to a level-two (L2) cache 265 via a crossbar 260 (or other type of interconnect network). The L2 cache 265 is connected to one or more memory interfaces 280. Memory interfaces 280 implement 16, 32, 64, 128-bit data buses, or the like, for high-speed data transfer. In one embodiment, the PPU 200 comprises U memory interfaces 280(U), where each memory interface 280(U) is connected to a corresponding memory device 204(U). For example, PPU 200 may be connected to up to 6 memory devices 204, such as graphics double-data-rate, version 5, synchronous dynamic random access memory (GDDR5 SDRAM).

In one embodiment, the PPU 200 implements a multi-level memory hierarchy. The memory 204 is located off-chip in SDRAM coupled to the PPU 200. Data from the memory 204 may be fetched and stored in the L2 cache 265, which is located on-chip and is shared between the various SMs 250. In one embodiment, each of the SMs 250 also implements an L1 cache. The L1 cache is private memory that is dedicated to a particular SM 250. Each of the L1 caches is coupled to the shared L2 cache 265. Data from the L2 cache 265 may be fetched and stored in each of the L1 caches for processing in the functional units of the SMs 250.

In one embodiment, the PPU 200 comprises a graphics processing unit (GPU). The PPU 200 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 200 can be configured to process the graphics primitives to generate a frame buffer (i.e., pixel data for each of the pixels of the display). The driver kernel implements a graphics processing pipeline, such as the graphics processing pipeline defined by the OpenGL API.

An application writes model data for a scene (i.e., a collection of vertices and attributes) to memory. The model data defines each of the objects that may be visible on a display. The application then makes an API call to the driver kernel that requests the model data to be rendered and displayed. The driver kernel reads the model data and writes commands to the buffer to perform one or more operations to process the model data. The commands may encode different shader programs including one or more of a vertex shader, hull shader, geometry shader, pixel shader, etc. For example, the TMU 215 may configure one or more SMs 250 to execute a vertex shader program that processes a number of vertices defined by the model data. In one embodiment, the TMU 215 may configure different SMs 250 to execute different shader programs concurrently. For example, a first subset of SMs 250 may be configured to execute a vertex shader program while a second subset of SMs 250 may be configured to execute a pixel shader program. The first subset of SMs 250 processes vertex data to produce processed vertex data and writes the processed vertex data to the L2 cache 265 and/or the memory 204. After the processed vertex data is rasterized (i.e., transformed from three-dimensional data into two-dimensional data in screen space) to produce fragment data, the second subset of SMs 250 executes a pixel shader to produce processed fragment data, which is then blended with other processed fragment data and written to the frame buffer in memory 204. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The PPU 200 may be included in a desktop computer, a laptop computer, a tablet computer, a smart-phone (e.g., a wireless, hand-held device), personal digital assistant (PDA), a digital camera, a hand-held electronic device, and the like. In one embodiment, the PPU 200 is embodied on a single semiconductor substrate. In another embodiment, the PPU 200 is included in a system-on-a-chip (SoC) along with one or more other logic units such as a reduced instruction set computer (RISC) CPU, a memory management unit (MMU), a digital-to-analog converter (DAC), and the like.

In one embodiment, the PPU 200 may be included on a graphics card that includes one or more memory devices 204 such as GDDR5 SDRAM. The graphics card may be configured to interface with a PCIe slot on a motherboard of a desktop computer that includes, e.g., a northbridge chipset and a southbridge chipset. In yet another embodiment, the PPU 200 may be an integrated graphics processing unit (iGPU) included in the chipset (i.e., Northbridge) of the motherboard.

FIG. 3 illustrates the streaming multi-processor 250 of FIG. 2, according to one embodiment. As shown in FIG. 3, the SM 250 includes an instruction cache 305, one or more scheduler units 310, a register file 320, one or more processing cores 350, one or more double precision units (DPUs) 351, one or more special function units (SFUs) 352, one or more load/store units (LSUs) 353, an interconnect network 380, a shared memory/L1 cache 370, and one or more texture units 390.

As described above, the work distribution unit 220 dispatches active grids for execution on one or more SMs 250 of the PPU 200. The scheduler unit 310 receives the grids from the work distribution unit 220 and manages instruction scheduling for one or more thread blocks of each active grid. The scheduler unit 310 schedules threads for execution in groups of parallel threads, where each group is called a warp. In one embodiment, each warp includes 32 threads. The scheduler unit 310 may manage a plurality of different thread blocks, allocating the thread blocks to warps for execution and then scheduling instructions from the plurality of different warps on the various functional units (i.e., cores 350, DPUs 351, SFUs 352, and LSUs 353) during each clock cycle.

In one embodiment, each scheduler unit 310 includes one or more instruction dispatch units 315. Each dispatch unit 315 is configured to transmit instructions to one or more of the functional units. In the embodiment shown in FIG. 3, the scheduler unit 310 includes two dispatch units 315 that enable two different instructions from the same warp to be dispatched during each clock cycle. In alternative embodiments, each scheduler unit 310 may include a single dispatch unit 315 or additional dispatch units 315.

Each SM 250 includes a register file 320 that provides a set of registers for the functional units of the SM 250. In one embodiment, the register file 320 is divided between each of the functional units such that each functional unit is allocated a dedicated portion of the register file 320. In another embodiment, the register file 320 is divided between the different warps being executed by the SM 250. The register file 320 provides temporary storage for operands connected to the data paths of the functional units.

Each SM 250 comprises L processing cores 350. In one embodiment, the SM 250 includes a large number (e.g., 192, etc.) of distinct processing cores 350. Each core 350 is a fully-pipelined, single-precision processing unit that includes a floating point arithmetic logic unit and an integer arithmetic logic unit. In one embodiment, the floating point arithmetic logic units implement the IEEE 754-2008 standard for floating point arithmetic. Each SM 250 also comprises M DPUs 351 that implement double-precision floating point arithmetic, N SFUs 352 that perform special functions (e.g., copy rectangle, pixel blending operations, and the like), and P LSUs 353 that implement load and store operations between the shared memory/L1 cache 370 and the register file 320. In one embodiment, the SM 250 includes 64 DPUs 351, 32 SFUs 352, and 32 LSUs 353.

Each SM 250 includes an interconnect network 380 that connects each of the functional units to the register file 320 and the shared memory/L1 cache 370. In one embodiment, the interconnect network 380 is a crossbar that can be configured to connect any of the functional units to any of the registers in the register file 320 or the memory locations in shared memory/L1 cache 370.

In one embodiment, the SM 250 is implemented within a GPU. In such an embodiment, the SM 250 comprises J texture units 390. The texture units 390 are configured to load texture maps (i.e., a 2D array of texels) from the memory 204 and sample the texture maps to produce sampled texture values for use in shader programs. The texture units 390 implement texture operations such as anti-aliasing operations using mip-maps (i.e., texture maps of varying levels of detail). In one embodiment, the SM 250 includes 16 texture units 390.

The PPU 200 described above may be configured to perform highly parallel computations much faster than conventional CPUs. Parallel computing has advantages in graphics processing, data compression, biometrics, stream processing algorithms, and the like.

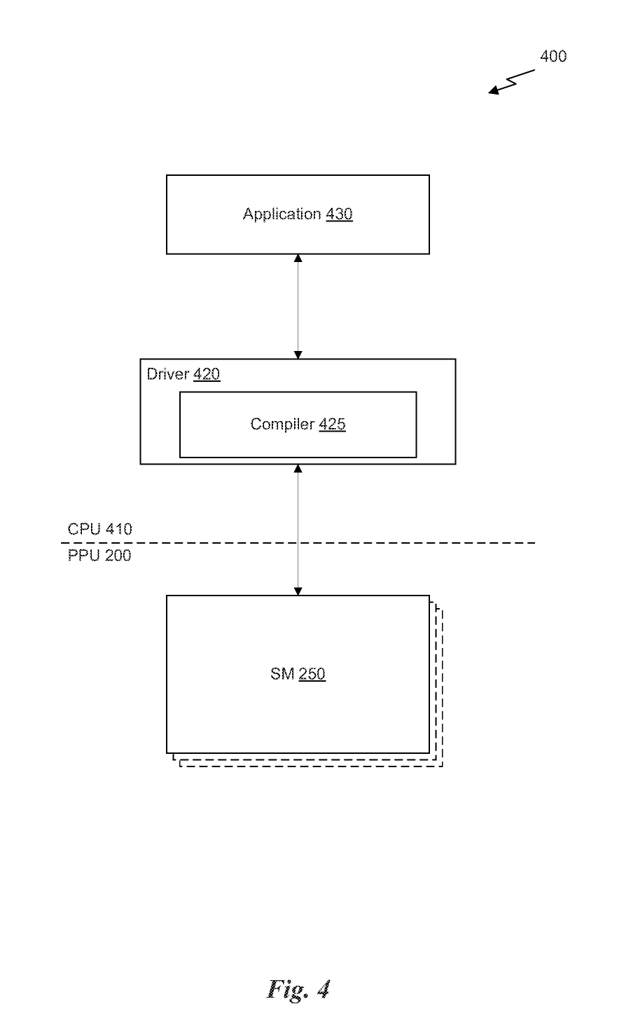

FIG. 4 illustrates a system 400 for enabling threads executing on the PPU 200 to yield control to a host processor, in accordance with one embodiment. As shown in FIG. 4, a host processor such as a central processing unit (CPU) 410 may be configured to execute a driver 420 associated with the PPU 200. The driver 420 may implement an application programming interface (API) that enables an application 430 to transmit commands (i.e., program instructions) to the driver 420 that cause the PPU 200 to execute one or more operations. The API may be, but is not limited to, a well-known API such as OpenGL or Microsoft® DirectX.

In operation, the driver 420 receives commands from the application 430. The commands may cause the driver to configure the PPU 200 to process a set of data. The commands may also include a pointer to program instructions (e.g., a shader) that specify a number of operations for processing the data by the PPU 200. In one embodiment, the driver 420 includes a compiler 425 that receives a shader program written in a high-level shading language such as Cg (C for Graphics) or Glslang (OpenGL Shading Language). The shader program may be compiled by a high-level compiler (not shown) that translates the high-level shading language syntax to an intermediate representation such as the PTX (Parallel Thread Execution) instruction set, which is an intermediary assembly language for NVIDIA's CUDA programming model, or the well-known LLVM (Low Level Virtual Machine) infrastructure. The compiler 425 receives the shader program in the intermediate representation and performs various optimizations before compiling the shader program into a low-level machine code for execution by the PPU 200. The low-level machine code is then copied into the memory 204 associated with the PPU 200 and a command is sent to the PPU 200 that points to the location of the shader program in the memory 204. When the PPU 200 receives the command, the PPU 200 configures one or more SMs 250 to execute the shader program on a set of data.

In one embodiment, the compiler 425 is configured to analyze the intermediate representation of the shader program to perform various optimizations. The compiler 425 may analyze the instructions in the shader program to generate an abstract control-flow graph data structure that represents the structural flow of the shader program. The compiler 425 may then use this control-flow graph during one or more passes to modify the intermediate representation of the shader program. For example, the compiler 425 may change the order of certain operations to reduce the impact of high-latency operations, may replace an instruction with one or more other instructions, or may make other hardware specific modifications to the intermediate representation.

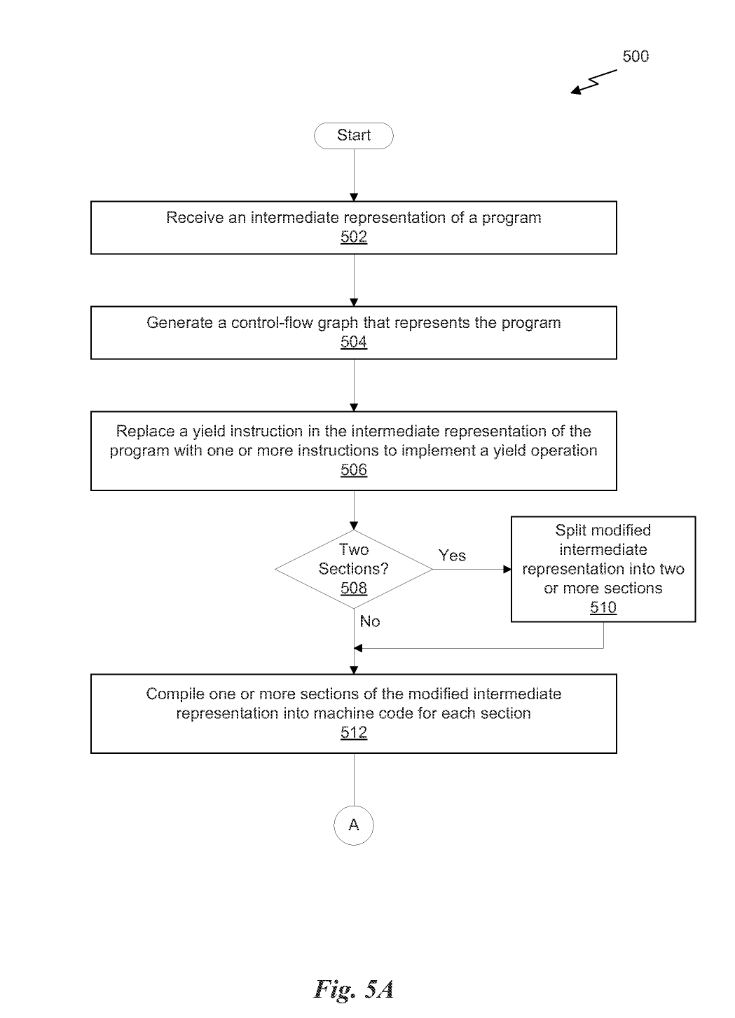

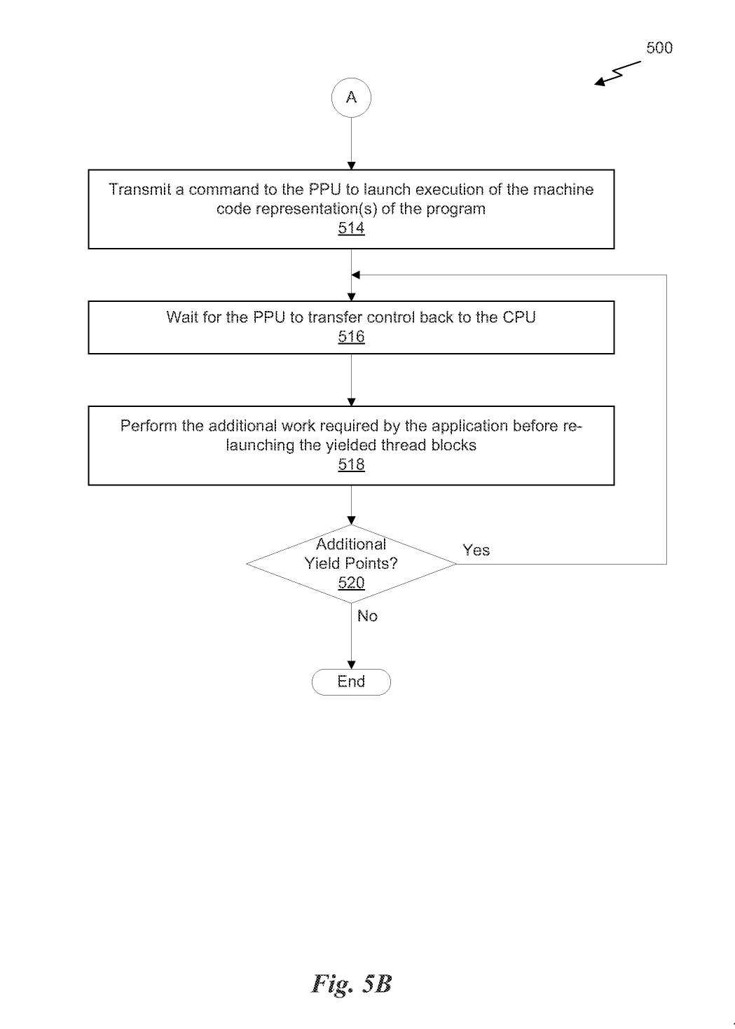

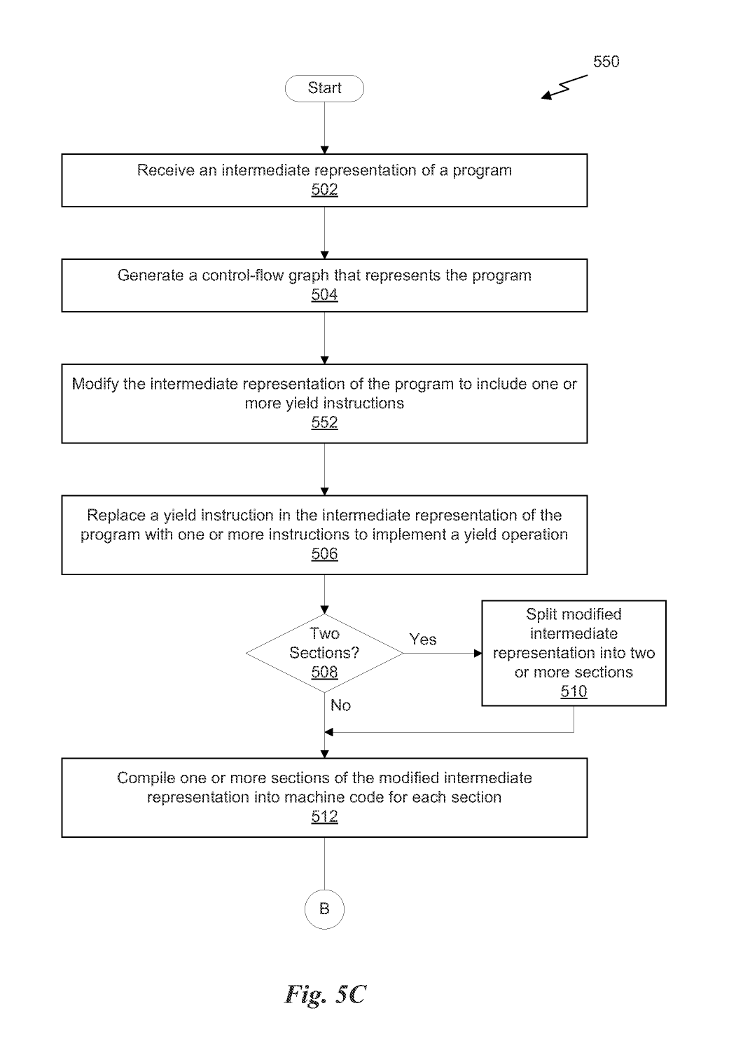

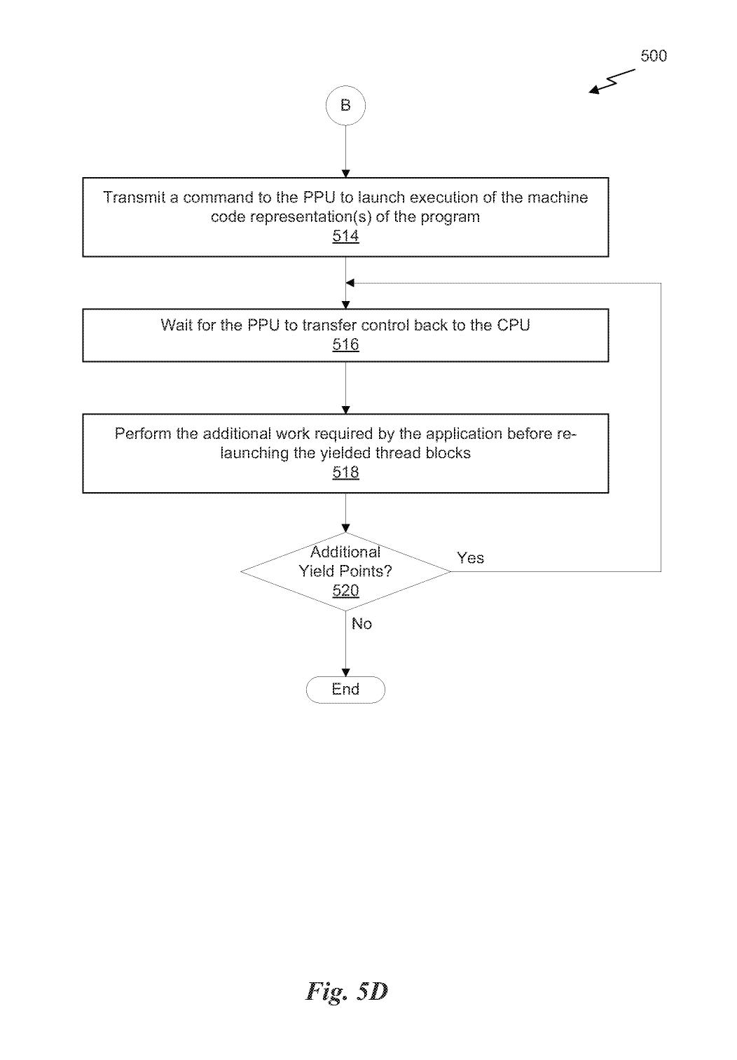

FIGS. 5A & 5B illustrate a flowchart for a method 500 for modifying an intermediate representation of a program to implement a yield operation, in accordance with one embodiment. In one embodiment, the program may be a shader program received by the compiler 425 in an intermediate representation. At step 502, the compiler 425 receives the intermediate representation of the program. At step 504, the compiler 425 generates a control-flow graph that represents the program. It will be appreciated that in some embodiments, step 504 is optional and other analysis techniques may be implemented by the compiler 425. At step 506, the compiler 425 performs a first pass that replaces a yield instruction in the intermediate representation for the program with one or more instructions for implementing a yield operation by the PPU 200. The yield instruction may be included in the intermediate representation by the compile-time compiler during the compilation of the high-level shading language into the intermediate representation. For example, a programmer may include a particular instruction in the high-level shading language that represents the yield instruction in the intermediate representation.

In one embodiment, the yield instruction represents a programming barrier that indicates that the threads executing on the PPU 200 should stop execution of any subsequent instructions in the program and yield control back to the CPU 410 such that the CPU 410 can perform some work. During execution of the thread block in the PPU 200, when the thread block reaches a yield instruction, the thread block saves any state necessary to continue execution after a resume and terminates execution, transmitting control back to the CPU 410. Once the CPU 410 has performed the work, the CPU 410 launches a continuation thread block and the PPU 200 resumes execution of the threads from a continuation point in the program immediately subsequent to the yield instruction. The saved state is restored and execution resumes at the continuation point.

Returning to step 506, the yield instruction may be replaced by the compiler 425 with one or more instructions that cause the state of the thread block to save any state information required to resume execution of the thread block at a later time. The state information may include register values associated with the state, a virtual program counter for the thread block, an active mask associated with the thread block, local memory for the thread block, as well as any other information necessary to resume execution at the continuation point. The compiler 425 may replace the yield instruction with explicit instructions for copying the necessary state information from the register file 320, shared memory/L1 cache 370, and/or another other memory locations of the PPU 200 to the memory 204. The compiler 425 may also allocate a portion of the memory 204, when the yield instruction is replaced in the intermediate representation, for a data structure to store the necessary state information. The data structure may also include an address that points to the continuation point in the program where the thread block is to resume when re-launched on the PPU 200. The yield instruction may also be replaced with one or more instructions that cause the PPU 200 to load the saved state information into the register file 320 and/or shared memory/L1 cache 370 of the PPU 200. The address for the continuation point may be set equal to the address for the first instruction that causes the saved state to be loaded into the local memory of the PPU 200.

At step 508, the compiler 425 determines whether the modified intermediate representation of the program can be split into two or more subprograms at the continuation points created by the yield instructions. If the compiler 425 determines that the modified intermediate representation of the program cannot be split into two or more subprograms, then, at step 512, the compiler 425 compiles the modified intermediate representation into machine code for execution by the PPU 200 and copies the machine code into the memory 204. The intermediate representation of the program may not be able to be split into two subprograms if the yield instruction is included in a conditional loop, for example. However, if the compiler 425 determines that the modified intermediate representation of the program can be split into two or more subprograms, then, at step 510, the compiler 425 splits the modified intermediate representation into two or more sections. The modified intermediate representation may be split into multiple sections if, for example, a first section of code above the yield instruction is independent from a second section of code below the yield instruction. Splitting the single shader program into two separate and distinct shader programs enables a more efficient use of resources because one section can be evicted from memory after it is executed as the instructions in the second section will never branch back to the first section. After the two or more sections are determined, at step 512, the compiler 425 compiles each section of the modified intermediate representation into machine code for execution by the PPU 200 and copies the two or more compiled sections of machine code into the memory 204.

At step 514, the driver 420 transmits a command to the PPU 200 to launch execution of the machine code representation(s) of the program. At step 516, the driver 420 waits for the PPU 200 to transfer control back to the CPU 410. In one embodiment, the compiler 425 replaces the yield instruction with, including one or more other instructions, an exit instruction that causes the thread block to terminate execution in the SM 250. This instruction causes the SM 250 to assert a Wait-For-Idle (WFI) signal that indicates that the thread block has finished execution. Once the WDU 220 receives a WFI signal from each of the SMs 250 with an active thread block, the WDU 220 causes the host interface unit 210 to transmit a signal to the CPU 410 that indicates that the thread block has yielded control to the CPU 410. At step 518, the driver 420 performs the additional work required by the application 410 before re-launching the yielded thread block from the continuation point.

In the case where the compiler 425 has split the modified intermediate representation into two or more sections, the driver 420 may launch a different thread block associated with the machine code for the next section of the intermediate representation pointed to by an address saved as the continuation point associated with the machine code for the previously yielded section of the intermediate representation. At step 520, the driver 420 determines whether there are additional yield instructions to be encountered during execution of the machine code, and, if so, the method 500 returns to step 516 to wait for control to be transferred back to the CPU 410. However, if there are no additional yield instructions to be encountered during execution of the machine code, then the method 500 terminates.

FIGS. 5C & 5D illustrate a flowchart for a method 550 for modifying an intermediate representation of a program to implement a yield operation, in accordance with another embodiment. Although method 500, described above, is applicable where a programmer has explicitly included an API function call within the high-level shading language, for example, and compiled the program using a high-level shading language compiler, some embodiments allow the compiler 425 to insert a yield instruction into the intermediate representation of the program based on the analysis of the control-flow graph. For example, even though the yield instruction is available to be inserted into the intermediate representation by the compiler 425, the yield instruction may not be visible to the programmer in the high-level shading language. In other words, the API implemented by the driver 420 may not include a function call to insert a yield instruction in the high-level shading language representation of the program. In such embodiments, during a first pass of the intermediate representation received by the compiler 425, the compiler 425 may insert one or more yield instructions into the intermediate representation of the program in order to allow the PPU 200 to transfer control back to the CPU 410 during execution.

As shown in FIGS. 5C & 5D, the method 550 includes steps 502 and 504 of method 500 where the compiler 425 receives the intermediate representation of the program and generates a control-flow graph that represents the program. At step 552, during a first pass of the intermediate representation of the program, the compiler 425 modifies the intermediate representation of the program to include one or more yield instructions. The yield instruction may be a single, unique semantic that represents a placeholder for one or more other instructions to be inserted by the compiler 425 during a subsequent pass of the modified intermediate representation. In one embodiment, the compiler 425 analyzes the control-flow graph using various techniques to determine points in the program where control should be yielded to the CPU 410.

For example, control may be yielded to the CPU 410 when the data set to be processed is too large for the available memory 204. In this case, a first portion of the data set can be copied into the memory 204 and processed by a first section of the program executed by the PPU 200 before yielding control back to the CPU 410. The CPU 410 may then copy the second portion of the data set into the memory 204 and launch a second section of the program to be executed by the PPU 200. The compiler 425 may do this in order to alleviate any issues associated with insufficient memory allocation. It will be appreciated that the compiler 425 may be configured to insert a yield instruction in any number of cases and the above case is provided for illustration only and should not be construed as limiting in any manner. After step 552, the method 550 continues with steps 506 through 520 of method 500, as described above.

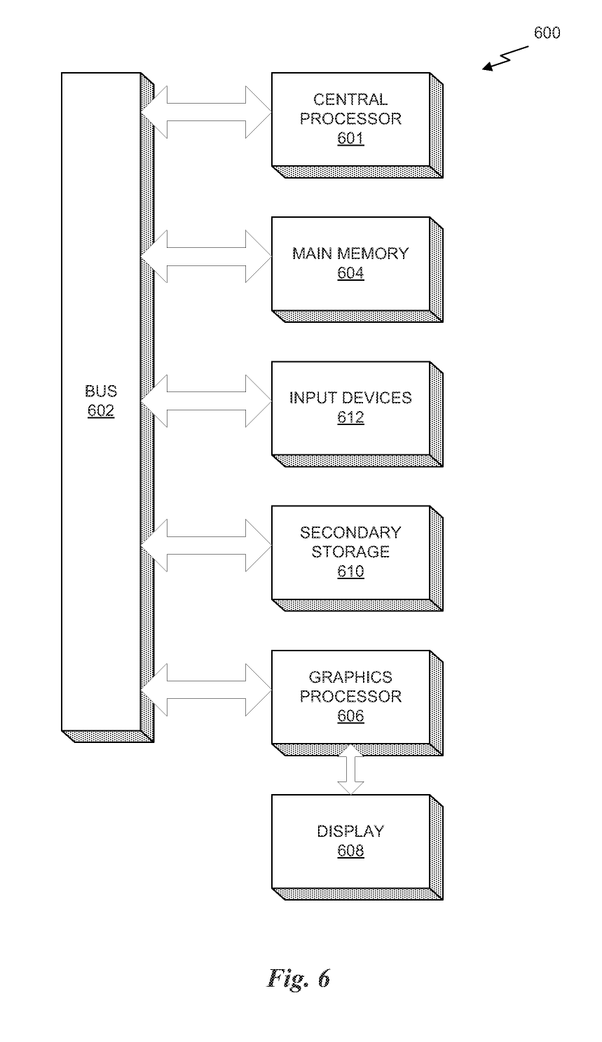

FIG. 6 illustrates an exemplary system 600 in which the various architecture and/or functionality of the various previous embodiments may be implemented. As shown, a system 600 is provided including at least one central processor 601 that is connected to a communication bus 602. The communication bus 602 may be implemented using any suitable protocol, such as PCI (Peripheral Component Interconnect), PCI-Express, AGP (Accelerated Graphics Port), HyperTransport, or any other bus or point-to-point communication protocol(s). The system 600 also includes a main memory 604. Control logic (software) and data are stored in the main memory 604 which may take the form of random access memory (RAM).

The system 600 also includes input devices 612, a graphics processor 606, and a display 608, i.e. a conventional CRT (cathode ray tube), LCD (liquid crystal display), LED (light emitting diode), plasma display or the like. User input may be received from the input devices 612, e.g., keyboard, mouse, touchpad, microphone, and the like. In one embodiment, the graphics processor 606 may include a plurality of shader modules, a rasterization module, etc. Each of the foregoing modules may even be situated on a single semiconductor platform to form a graphics processing unit (GPU). In one embodiment, the graphics processor 606 may comprise PPU 200 and the CPU 601 may comprise the CPU 410, which is configured to execute the driver 420/compiler 425.

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 600 may also include a secondary storage 610. The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 604 and/or the secondary storage 610. Such computer programs, when executed, enable the system 600 to perform various functions. The memory 604, the storage 610, and/or any other storage are possible examples of computer-readable media.

In one embodiment, the architecture and/or functionality of the various previous figures may be implemented in the context of the central processor 601, the graphics processor 606, an integrated circuit (not shown) that is capable of at least a portion of the capabilities of both the central processor 601 and the graphics processor 606, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 600 may take the form of a desktop computer, laptop computer, server, workstation, game consoles, embedded system, and/or any other type of logic. Still yet, the system 600 may take the form of various other devices including, but not limited to a personal digital assistant (PDA) device, a mobile phone device, a television, etc.

Further, while not shown, the system 600 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
receiving an intermediate representation of a program;
replacing a yield instruction in the intermediate representation with a yield operation that includes one or more instructions; and
compiling at least a portion of the modified intermediate representation into a machine code for execution on a parallel processing unit.

2. The method of claim 1, further comprising:
determining that the modified intermediate representation can be split into two or more sections, wherein the at least a portion of the modified intermediate representation comprises a first section of the two or more sections; and
compiling at least a second portion of the modified intermediate representation into a second machine code for execution on the parallel processing unit.

3. The method of claim 1, further comprising generating a control-flow graph associated with the intermediate representation of the program.

4. The method of claim 1, wherein the intermediate representation is represented using a Parallel Thread Execution (PTX) instruction set architecture.

5. The method of claim 1, wherein the intermediate representation is represented using a Low Level Virtual Machine (LLVM) compiler infrastructure.

6. The method of claim 1, wherein the yield operation includes a first set of instructions that cause the parallel processing unit to save state information associated with a thread block to a data structure in a memory and terminate execution of the thread block to transfer control back to a host processor.

7. The method of claim 6, wherein the yield operation includes a second set of instructions that cause the parallel processing unit to restore the state information associated with the thread block to one or more registers in the parallel processing unit.

8. The method of claim 7, wherein a first instruction in the second set of instructions is specified as a continuation point and an address that points to the first instruction is stored with the state information in the data structure.

9. The method of claim 1, further comprising:
copying the machine code to a memory associated with the parallel processing unit; and
transmitting a command to the parallel processing unit that causes the parallel processing unit to launch one or more thread blocks that are configured to execute the machine code.

10. The method of claim 9, further comprising:
determining that the parallel processing unit has completed execution of each of the one or more thread blocks;
performing additional work via a host processor; and
transmitting a second command to the parallel processing unit that causes the parallel processing unit to re-launch the one or more thread blocks to execute the machine code from a continuation point.

11. The method of claim 1, further comprising compiling a high-level shading language version of the program into the intermediate representation.

12. The method of claim 11, wherein the high-level shading language is Cg (C for graphics).

13. The method of claim 1, further comprising modifying the intermediate representation of the program to include one or more yield instructions.

14. The method of claim 1, wherein the yield instruction is a single, unique semantic that represents a point in the program where the parallel processing unit stops execution of a thread block and yields control back to a host processor.

15. A computer-readable storage medium storing instructions that, when executed by a processor, causes the processor to perform steps comprising:
receiving an intermediate representation of a program;
replacing a yield instruction in the intermediate representation with a yield operation that includes one or more instructions; and
compiling at least a portion of the modified intermediate representation into a machine code for execution on a parallel processing unit.

16. The computer-readable medium of claim 15, the steps further comprising:
determining that the modified intermediate representation can be split into two or more sections, wherein the at least a portion of the modified intermediate representation comprises a first section of the two or more sections; and
compiling at least a second portion of the modified intermediate representation into a second machine code for execution on the parallel processing unit

17. The computer-readable medium of claim 15, wherein the yield operation includes a first set of instructions that cause the parallel processing unit to save state information associated with a thread block to a data structure in a memory and terminate execution of the thread block to transfer control back to a host processor.

18. A system, comprising:
A parallel processing unit; and
a host processor, coupled to the parallel processing unit, that executes a compiler configured to:
receive an intermediate representation of a program,
replace a yield instruction in the intermediate representation with a yield operation that includes one or more instructions, and
compile at least a portion of the modified intermediate representation into a machine code for execution on the parallel processing unit.

19. The system of claim 18, further comprising a memory associated with the parallel processing unit, the compiler further configured to:
copy the machine code to the memory, and
transmit a command to the parallel processing unit that causes the parallel processing unit to launch one or more thread blocks that are configured to execute the machine code.

20. The system of claim 18, wherein the yield operation includes a first set of instructions that cause the parallel processing unit to save state information associated with a thread block to a data structure in a memory and terminate execution of the thread block to transfer control back to the host processor.
